(19) United States
(12) Patent Application Publication
(10) Pub. No.: US 2009/0147276 A1
(43) Pub. Date: Jun. 11, 2009

(54) Image Recording Apparatus, Image Recording Method, Data Structure, Recording Medium, Data Processing Apparatus and Method

(76) Inventor: Mitsuru Mushano, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/990,851

(22) PCT Filed: Sep. 28, 2006
(86) PCT No.: PCT/JP2006/319920

§ 371 Date: Feb. 22, 2008

(30) Foreign Application Priority Data
Sep. 30, 2005 (JP) 2005288762

(51) Int. Cl. G06K 15/10; H04N 1/60

(52) U.S. Cl. 358/1.8; 358/1.9

(57) ABSTRACT

A compressed mirror data generator converts compressed data transmitted from a RIP server into compressed mirror data to be supplied to micromirrors of DMDS, and transmits the compressed data to an exposure unit. A frame data generator of the exposure unit decompresses the compressed mirror data, converts the decompressed mirror data into frame data, and supplies the frame data through a DMD controller to the DMDs, thereby controlling DMD micromirrors to record an image by way of exposure.

### TECHNICAL FIELD

The present invention relates to an image recording apparatus, an image recording method, a data structure, a recording medium, a data processing apparatus and method for forming a two-dimensional image on an image recording surface, by relatively moving an image recording dot forming unit, having a plurality of image recording components for forming an image recording dot group of a plurality of image recording dots, in a predetermined scanning direction over the image recording surface, successively supplying frame data, which are made up of a plurality of image recording data corresponding to the image recording dot group, to the image recording dot forming unit, and forming the image recording dot group on a chronological basis.

### BACKGROUND ART

Heretofore, there have been known various image recording apparatuses, for recording a desired two-dimensional image on an image recording surface, based on image recording data.

For example, various exposure apparatuses, incorporating therein spatial light modulators, comprising digital micromirror devices (DMDs) or the like, for modulating a light beam with image recording data have been proposed.

A DMD comprises a number of memory cells (SRAMs) disposed on a semiconductor substrate of silicon or the like, and a two-dimensional matrix of micromirrors disposed on the memory cells. The micromirrors are tilted by electrostatic forces produced by charges that accumulate in the memory cells based on image recording data, thus changing the angles of reflecting surfaces of the micromirrors, for thereby forming image recording dots at desired positions on an image recording surface to form an image thereon.

One type of exposure apparatus, which employs a DMD, records a desired image by relatively moving the DMD in a predetermined scanning direction with respect to an exposure surface, entering image recording data into the memory cells of the DMD depending on movement of the DMD in the scanning direction, and forming a group of image recording dots, according to tilting of the micromirrors based on the image recording data, chronologically on the exposure surface (see Japanese Laid-Open Patent Publication No. 2004-56100). There has also been proposed an exposure apparatus having a DMD inclined at a certain angle to the scanning direction in order to reduce the spacing between micromirrors on the exposure surface in a direction perpendicular to the scanning direction, for thereby increasing resolution of an image that is recorded on the exposure surface.

For forming an image on an exposure surface using such an exposure apparatus, it is necessary to generate frame data, wherein the image recording data thereof are established depending on the position of the DMD with respect to the exposure surface and the array of memory cells.

A conventional process of generating frame data to form a numeral “2” on an exposure surface shall be described below with reference to FIGS. 14A through 14E, 15A through 15E, and 16A through 16E of the accompanying drawings. In FIGS. 14A through 16E, symbols [symbol] - [symbol] , \textcircled{1}-\textcircled{8} schematically represent respective positions of eight micromirrors that make up one DMD with respect to the exposure surface. The DMD is inclined at a certain angle with respect to the scanning direction.

Frames 1 through 15, as shown in lower ends of FIGS. 14A through 16E, schematically represent frame data that are entered into the respective memory cells of the DMD, when the DMD is in the illustrated positions.

For example, after image recording data corresponding to the respective image recording dots shown in FIGS. 14A through 16E are stored temporarily in a memory such as a DRAM or the like, the image recording data corresponding to micromirrors ( [symbol] - [symbol] ) of the DMD are successively read from the memory, at the respective positions of the DMD shown in FIGS. 14A through 16E. Then, frame data made up of the image recording data, which are arranged in a sequence of the addresses of the micromirrors, are generated as shown in FIG. 17 of the accompanying drawings.

In FIGS. 14A through 16E, the image recording data represented by blank squares and hatched squares indicate turn-off data “0” for the micromirrors, and the image recording data represented by solid squares indicate turn-on data “1” for the micromirrors. A range indicated by the hatched squares represents a substantial range of an image recorded on the image recording surface, having image recording data as turn-off data “0”.

The frame data thus generated are then successively read in the order of frames 1 through 15, and entered into the memory cells of the DMD. Based on the frame data, the micromirrors are controlled to form a desired image on the exposure surface.

If the exposure area is large, or if the resolution of the formed image is high, then the amount of frame data required for forming the image also needs to be large. If the frame data are transferred between image recording apparatuses, or processed by the image recording apparatus, then the processing rate tends to be lowered, and the processing burden on the image recording apparatus is liable to increase.

One solution is to reduce the amount of frame data by first compressing the frame data, and then to transfer and process the frame data. However, as can be seen from FIG. 17, the frame data comprise highly random data, as compared with the image recording data for the numeral “2” shown in FIGS. 14A through 16E. Therefore, it is difficult to achieve a sufficient data compression ratio for the frame data. The reason for this is, because the frame data are not arranged as an array of image recording data along the image to be formed, but rather are arranged according to the array of micromirrors which are arranged discretely with respect to the image, the adjacent image recording data of the frame data lack continuity.

### DISCLOSURE OF INVENTION

A general object of the present invention is to provide an image recording apparatus, an image recording method, a data structure, a recording medium, a data processing apparatus and a method for compressing image recording data at a high data compression ratio, so as to allow the image recording data to be processed at high speed, and to reduce the capacity required for storing the image recording data.

A major object of the present invention is to provide an image recording apparatus, an image recording method, a data structure, a recording medium, and a data processing apparatus and method, for allowing parallel processing to be performed on image recording data for high-speed data processing, while enabling simple apparatus configurations.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF DRAWINGS

FIG. 1 is a block diagram of an exposure recording system according to an embodiment of the present invention;

FIG. 2 is a perspective view of the exposure recording system;

FIG. 3 is a schematic elevational view, partly in block form, of each of the exposure heads of the exposure recording system;

FIG. 4 is an enlarged fragmentary perspective view of a DMD of the exposure head;

FIG. 5 is a perspective view showing the relationship between the exposure heads and a board positioned on an exposure stage;

FIG. 6 is a plan view showing the relationship between the exposure heads and exposure areas on the board;

FIG. 7 is a flowchart indicating a processing sequence of the exposure recording system;

FIG. 8 is a diagram showing the relationship between image recording data and lines of an image;

FIG. 9 is a diagram showing compressed data of the image recording data shown in FIG. 8;

FIG. 10 is a diagram showing the positional relationship between scanning paths of the micromirrors of three DMDs and the image recording data;

FIG. 11 is a diagram showing compressed mirror data supplied to the micromirrors shown in FIG. 10;

FIG. 12A is a diagram showing mirror data produced when the compressed mirror data shown in FIG. 11 are decompressed;

FIG. 12B is a diagram showing the number of compressed mirror data;

FIG. 13A is a diagram showing frame data;

FIG. 13B is a diagram showing the number of compressed frame data;

FIGS. 14A, 14B, 14C, 14D, and 14E are diagrams illustrating a conventional process for generating frame data;

FIGS. 15A, 15B, 15C, 15D, and 15E are further diagrams illustrating the conventional process for generating frame data;

FIGS. 16A, 16B, 16C, 16D, and 16E are further diagrams illustrating the conventional process for generating frame data; and

FIG. 17 is a diagram showing the frame data stored in a memory.

### BEST MODE FOR CARRYING OUT THE INVENTION

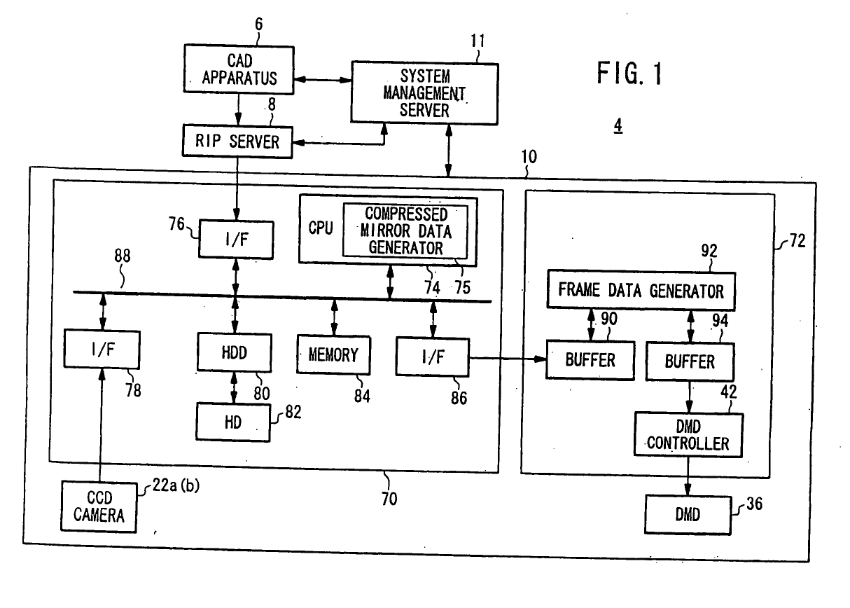

FIG. 1 shows in block form an exposure recording system 4 according to an embodiment of the present invention.

As shown in FIG. 1, the exposure recording system 4 essentially comprises a CAD apparatus 6 for outputting data of a two-dimensional image to be formed by way of exposure as vector data, a raster image processor server (RIP server) 8 for converting the vector data output from the CAD apparatus 6 into raster image data, compressing the raster image data according to run-length encoding, and outputting the compressed data, an exposure recording apparatus 10 for generating chronological data for each image recording component (compressed mirror data) from the compressed data sent from the RIP server 8, decompressing the compressed mirror data into frame data, and recording an image on an image recording surface of a board by way of exposure based on the frame data, and a system management server 11 for managing and controlling the CAD apparatus 6, the RIP server 8, and the exposure recording apparatus 10.

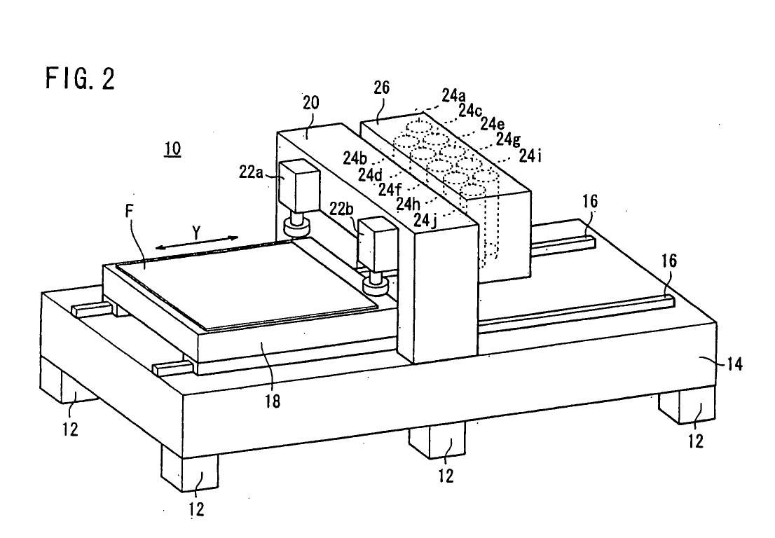

The exposure recording apparatus 10 exposes a laminated printed wiring board or the like to light based on the frame data. The exposure recording apparatus 10 is constructed as shown in FIG. 2.

As shown in FIG. 2, the exposure recording apparatus 10 has a bed 14, which is substantially free of deformations, supported by a plurality of legs 12, and an exposure stage 18 mounted on the bed 14 by means of two parallel guide rails 16 for enabling reciprocating movement in the directions indicated by the arrow Y. An elongate rectangular board F, having a photosensitive material coated thereon, is attracted to and held on the exposure stage 18. The coated surface of the board F, i.e., the upper surface thereof as shown in FIG. 2, serves as an image recording surface.

A portal column 20 is mounted centrally on the bed 14 over the guide rails 16. Two CCD cameras 22a, 22b are fixed to one side of the column 20, for obtaining alignment information representing misalignment of the board F with respect to the exposure stage 18, deformation of the board F, etc. A scanner 26, having a plurality of exposure heads 24a through 24j positioned and held therein for recording an image on the board F by way of exposure, is fixed to the other side of the column 20.

The exposure heads 24a through 24j are arranged in two staggered rows (i.e., in a substantially matrix pattern) in a direction perpendicular to the directions indicated by the arrow Y in which the board F is movable.

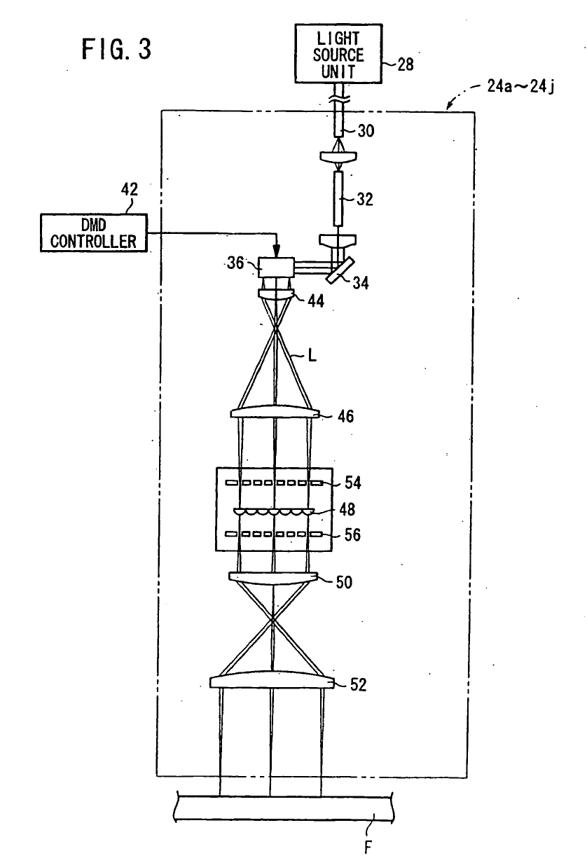

FIG. 3 shows schematically, partly in block form, each of the exposure heads 24a through 24j. Each of the exposure heads 24a through 24j is supplied with a combined laser beam L, which is emitted from a plurality of semiconductor laser devices from a light source unit 28 and introduced through an optical fiber 30. The exiting end of the optical fiber 30 is followed successively by a rod lens 32, a reflecting mirror 34, and a digital micromirror device (DMD) 36, serving as an image recording dot forming unit.

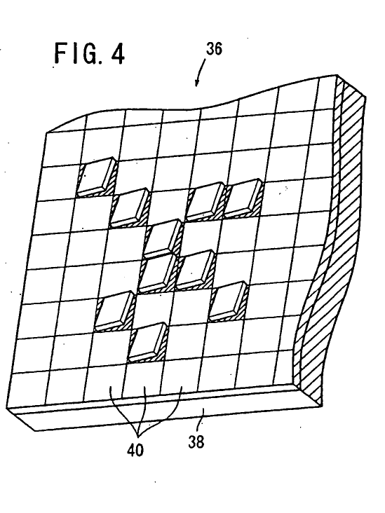

As shown in FIG. 4, the DMD 36 comprises a number of micromirrors 40 (image recording components) swingably arrayed in a grid-like pattern on a SRAM array 38. The surface of each of the micromirrors 40 is coated with a material having a high reflectance, such as aluminum or the like, by way of evaporation coating. When a digital signal in accordance with the frame data is written into the SRAM array 38 from a DMD controller 42, the micromirrors 40 are selectively tilted in a given direction, i.e., selectively turned on and off, depending on the digital signal, thereby selectively turning the laser beam L on and off.

As shown in FIG. 4, the laser beam L, which is reflected by selectively turning on and off the micromirrors 40 of the DMD 36, travels successively through two first focusing optical lenses 44 and 46, each of which forms a magnifying optical system, a microlens array 48 comprising a number of lenses corresponding respectively to the micromirrors 40 of the DMD 36, and two second focusing optical lenses 50 and 52, each of which forms a zoom optical system. The microlens array 48 is preceded and followed by respective microaperture arrays 54, 56, which operate to remove stray light and adjust the laser beam L to a desired beam spot diameter.

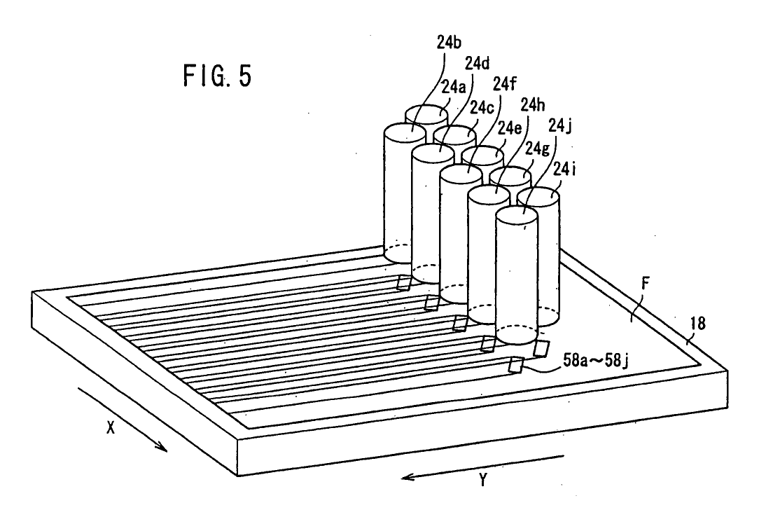

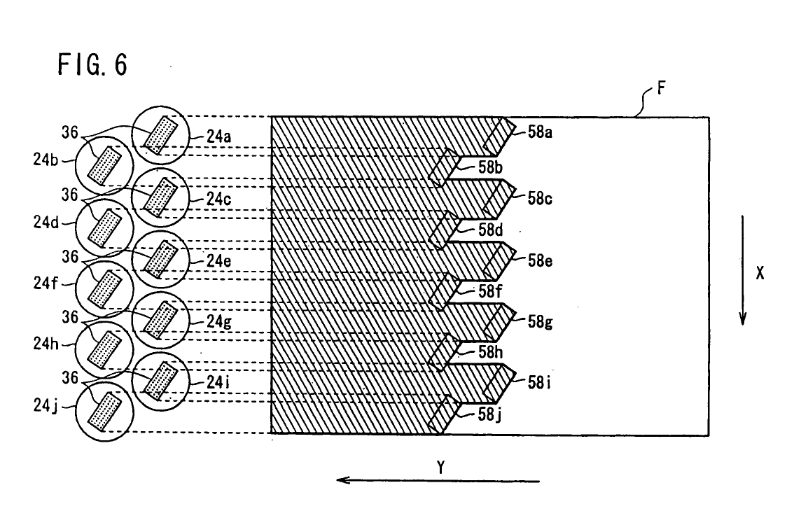

As shown in FIGS. 5 and 6, the DMDs 36, which incorporate the respective exposure heads 24a through 24j therein, are inclined at a predetermined angle to the directions indicated by the arrow Y in which the board F is movable, so as to achieve high resolution. Specifically, since the DMDs 36 are inclined with respect to the directions in which the board F is movable, the spacing between the micromirrors 40 is reduced in directions indicated by the arrow X, which are perpendicular to the directions indicated by the arrow Y, thereby increasing resolution of the image that is recorded in the directions indicated by the arrow X. The image resolution in the directions indicated by the arrow Y can also be adjusted by changing the speed at which the board F moves and/or the speed at which the micromirrors 40 are operated to modulate the laser beam L. As shown in FIG. 6, exposure areas 58a through 58j, which are exposed at one time by the respective exposure heads 24a through 24j, are arranged so as to overlap in the directions indicated by the arrow X, thereby making the exposure heads 24a through 24j seamless in such directions.

As shown in FIG. 1, the exposure recording apparatus 10 includes a control circuit having a data processor 70 for generating beam path information for the laser beam L with respect to the board F, based on alignment information representing misalignment of the board F with respect to the exposure stage 18, or information representing deformations in the board F, etc., acquired from the CCD cameras 22a, 22b, and mirror layout information of the micromirrors 40 with respect to the image recording surface. The data processor 70 also converts compressed data into compressed mirror data, which are mirror-specific image recording data (image recording component chronological data) supplied chronologically to the micromirrors 40, according to the beam path information. In addition, the exposure recording apparatus 10 includes an exposure unit 72 for decompressing the compressed mirror data supplied from the data processor 70 into frame data, and actuating the DMDs 36 based on the frame data, in order to record an image on the board F by way of exposure.

The data processor 70 comprises a personal computer, for example, having a CPU 74 that functions as a compressed mirror data generator (image recording component chronological data generating means) 75 for generating compressed mirror data based on beam path information. To the CPU 74, there are connected, through a bus 88, an interface (I/F) 76 for receiving compressed data sent from the RIP server 8, an interface (I/F) 78 for receiving alignment information of the board F acquired from the CCD cameras 22a, 22b, a hard disk (HD) 82 for storing the compressed data sent from the RIP server 8 through a hard disk drive (HDD) 80, a memory (image recording component chronological data holding means) 84 serving as a recording medium, and an interface (I/F) 86 for transmitting the compressed mirror data generated by the compressed mirror data generator 75 to the exposure unit 72. The memory (image recording component chronological data holding means) 84 forms a main storage unit for storing compressed data read from the HD 82, alignment information of the board F, mirror layout information of the micromirrors 40 with respect to the board F, beam path information generated from the alignment information and the mirror layout information, and compressed mirror data produced by processing the compressed data based on the beam path information.

The exposure unit 72 comprises a buffer 90 serving as a memory for temporarily storing the compressed mirror data sent from the I/F 86 of the data processor 70, a frame data generator 92 for converting the compressed mirror data stored in the buffer 90 into frame data according to the array of micromirrors 40 of the DMD 36, a buffer 94 serving as a memory for temporarily storing the frame data, and a DMD controller 42 for controlling the micromirrors 40 of the DMD 36 to record an image on the board F by way of exposure.

The frame data generator 92 decompresses the compressed mirror data stored in the buffer 90 into mirror data, and transposes the mirror data into frame data for each of the DMDs 36.

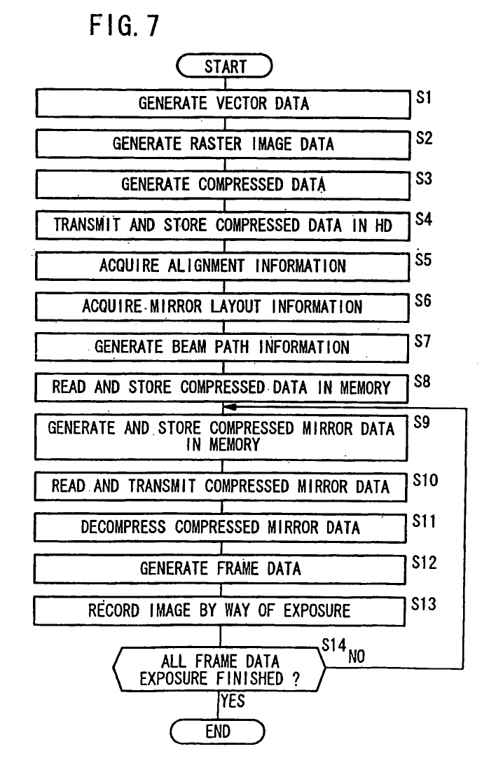

The exposure recording system according to the embodiment of the present invention is basically constructed as described above. Operations and advantages of the exposure recording system shall be described below with reference to FIG. 7.

In step S1, the CAD apparatus 6 generates data of a two-dimensional image to be recorded on the board F as vector data. The vector data generated by the CAD apparatus 6 are sent to the RIP server 8.

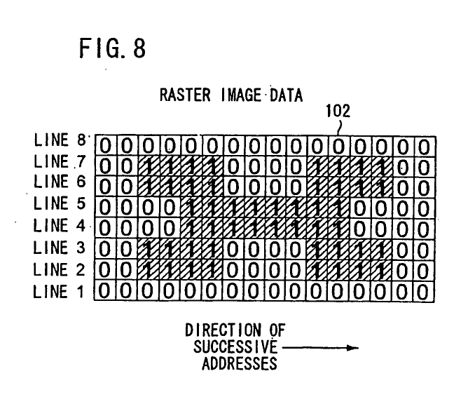

In step S2, the RIP server 8 converts the vector data into raster image data 102, as shown in FIG. 8. The raster image data 102 represent lines 1 through 8 of pixels having a predetermined resolution divided from an image to be recorded on the board F, wherein each of the lines 1 through 8 is expressed as bit map data made up of pixels “0” and “1”. The raster image data 102 are generated such that the direction in which the board F moves is the same as the direction of successive addresses.

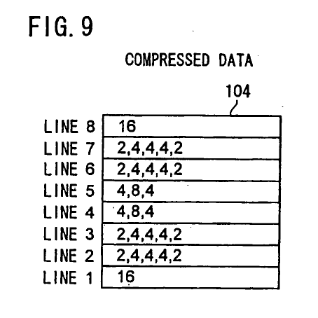

Then, in step S3, the RIP server 8 compresses the raster image data 102, according to run-length encoding, thereby producing run-length compressed data 104, as shown in FIG. 9.

As shown in FIG. 9, the compressed data 104 are represented, for each of the lines 1 through 8, by a number of successive pixels “0” of the raster image data 102 in the direction of the line, and a number of successive pixels “1” of the raster image data 102 in the direction of the line. For example, since the line 1 has 16 successive pixels “0” in the direction of the line, the run-length compressed data 104 for the line 1 are represented by “16”, and since the line 2 has 2 successive pixels “0”, 4 successive pixels “1”, 4 successive pixels “0”, 4 successive pixels “1”, and 2 successive pixels “0” in the direction of the line, the run-length compressed data 104 for the line 2 are represented by “2, 4, 4, 4, 2”.

The compressed data 104 generated by the RIP server 8 are sent from the RIP server 8 to the data processor 70 of the exposure recording apparatus 10. In the exposure recording apparatus 10, the compressed data 104 are transmitted through the interface 76, the bus 88, and the HDD 80, and then stored in the HD 82 in step S4. Inasmuch as the compressed data 104 are in the form of run-length compressed data, they can be transmitted at high speed to the data processor 70, and can be stored as a small amount of data in the HD 82.

Then, operation of the exposure recording apparatus 10 is initiated. After the board F has been placed in a predetermined position on the exposure stage 18, the exposure stage 18 is moved in a direction from the CCD cameras 22a, 22b toward the scanner 26. As the exposure stage 18 moves, the CCD cameras 22a and 22b capture images of the board F, and acquire alignment information representing misalignment of the board F with respect to the exposure stage 18, deformations in the board F, etc., in step S5. The acquired alignment information is stored in the memory 84.

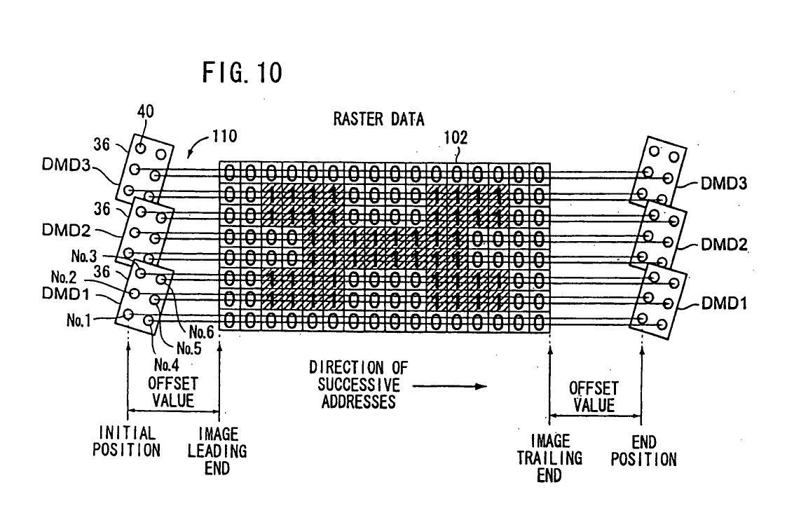

As shown in FIG. 10, the micromirrors 40 of the DMDs 36 are arranged in different positions. The mirror layout information may be preset in the system management server 11, or may be measured by a sensor when the exposure heads 24a through 24j are energized to output the laser beam L. The data processor 70 acquires the mirror layout information in step S6, and stores the mirror layout information in the memory 84.

In step S7, using the acquired alignment information and mirror layout information, the CPU 74 generates beam path information indicative of scanning paths 110, along which the laser beam L led from the micromirrors 40 to the board F is to scan the board F.

Then, in step S8, the compressed mirror data generator 75 of the data processor 70 reads from the HD 82 the compressed data 104 representing an image to be formed on the image recording surface of the board F, and stores the compressed data 104 in the memory 84. Thereafter, using the beam path information generated in step S7, the compressed mirror data generator 75 generates compressed mirror data to be supplied chronologically to the micromirrors 40. The generated compressed mirror data are stored in the memory 84 in step s9.

FIG. 10 schematically shows the scanning paths 110 for the laser beam L, which is applied from the micromirrors 40 to the board F, based on the assumption that there are three DMDs 1 through 3, rather than the 10 DMDs 36 corresponding to the exposure heads 24a through 24j, and wherein each of the three DMDs 1 through 3 comprises 6 micromirrors 40, numbered respectively as No. 1 through No. 6.

The No. 1 micromirror 40 and the No. 4 micromirror 40 of the DMD 1, for example, move along the scanning path 110 on the same line 1 (see also FIG. 8) of the raster image data 102. The No. 2 micromirror 40 and the No. 5 micromirror 40 of the DMD 1 move along the scanning path 110 on the same line 2 (see also FIG. 8) of the raster image data 102. In this manner, plural micromirrors are assigned to one line of the raster image data 102 to enable increased resolution.

The scanning paths 110 include respective offset values. One of such offset values is produced by dividing, by the resolution, the distance from an initial position of each micromirror 40 (each beam) to a leading end of the image, and the other offset value is produced by dividing, by the resolution, the distance from a trailing end of the image to an end position of each micromirror 40.

The scanning paths 110 shown in FIG. 10 extend in parallel with the direction of the lines of the image. Actually, since the board F or other system components could possibly be deformed, the scanning paths 110 may be corrected based on the alignment information acquired from the CCD cameras 22a, 22b.

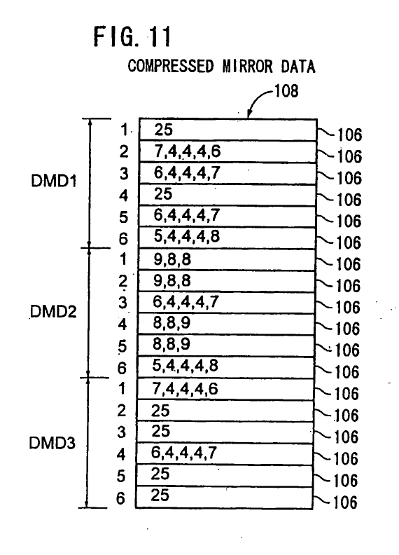

FIG. 11 shows compressed mirror data 108, which is generated based on the scanning paths 110 and the compressed data 104. For example, the compressed mirror data 108 for the No. 2 micromirror 40 of the DMD 1 are made up of 7“0”s, including an offset value of “5” from the initial position to the image leading end (image recording data of “0” since there is no exposure involved), 2“0”s because the first 2 image recording data for the line 2 of the raster image data 102 are turn-off data, 4“1”s, 4“0”s, 4“1”s, and 6“0”s, including 2“0”s and an offset value of “4”, from the image trailing end to the end position. Therefore, the compressed mirror data 108 for the micromirror 40 corresponding to line 2 of the DMD 1 are represented by 7“0”s, 4 “1”s, 4“0”s, 4 “1”s, and 6“0”s. The compressed mirror data 108 are managed in a similar manner with respect to each of the micromirrors 40.

In step 10, the generated compressed mirror data 108 (see FIG. 11) are read from the memory 84 of the data processor 70, sent to the buffer 90 of the exposure unit 72, and temporarily stored in the buffer 90.

Since the compressed mirror data 108 are in the form of run-length compressed data, the compressed mirror data 108 can be transmitted at high speed to the exposure unit 72. The compressed mirror data 108 stored in the memory 84 can be divided into a plurality of data groups, which can be supplied to respective micromirrors 40 or respective groups of micromirrors 40. Such data groups of compressed mirror data 108 can be read at the same time from the memory 84 and transmitted in a parallel relationship to the exposure unit 72. Therefore, the compressed mirror data 108 can be transmitted at high speed. Such parallel data transmission is also applicable to uncompressed mirror data.

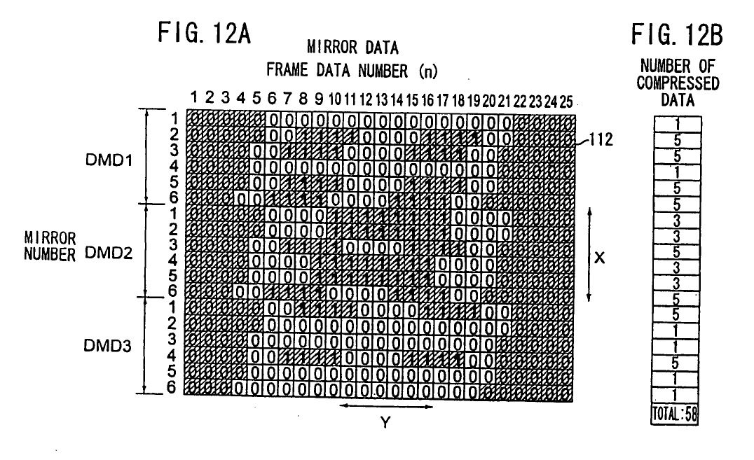

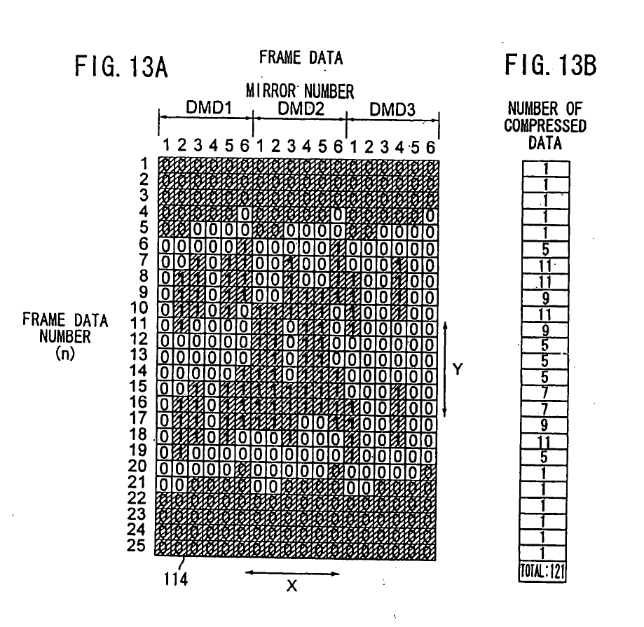

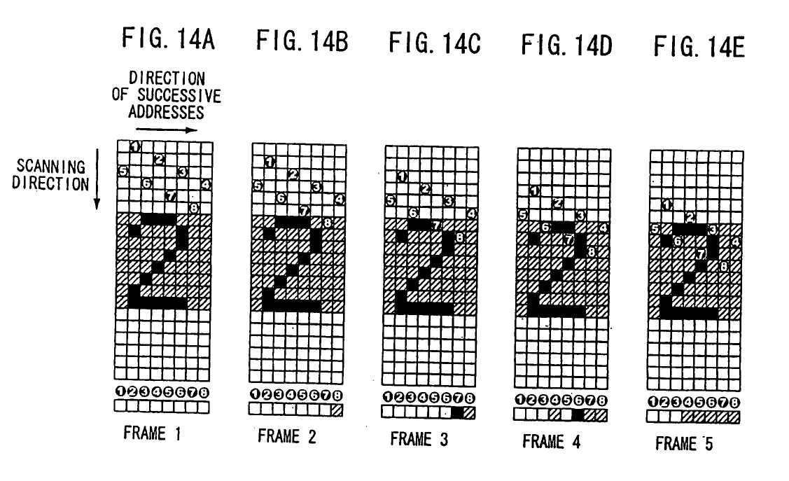

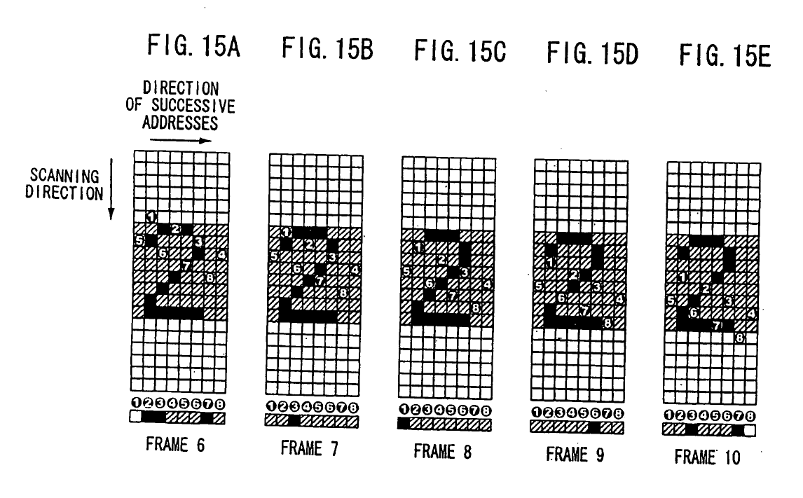

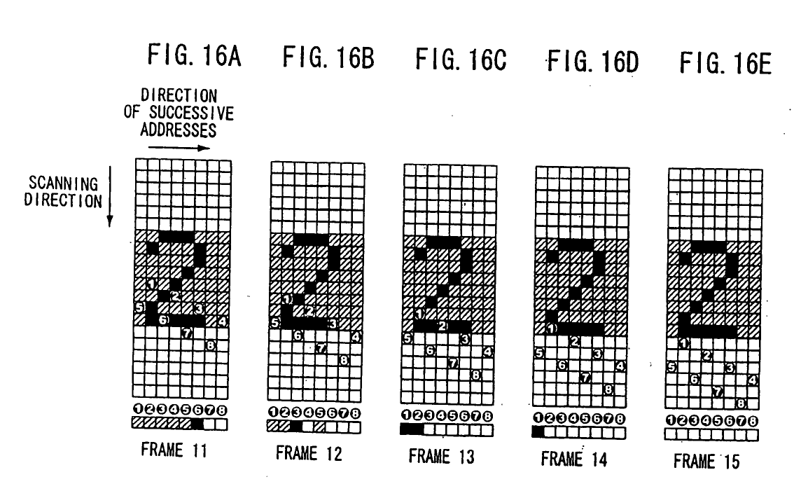

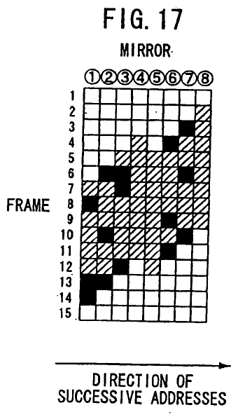

Then, in step S11, the frame data generator 92 decompresses the compressed mirror data 108 stored in the buffer 90 into mirror data 112 (see FIG. 12A), and in step S12, transposes the mirror data 112 into frame data 114 (see FIG. 13A).

The mirror data 112 comprise data that is chronologically established for each of the No. 1 to No. 6 micromirrors 40 of the DMDs 1 through 3. In FIG. 12A, the chronological data are represented by frame data numbers n (n=1 through 25). The frame data 114 are generated by transposing rows of mirror numbers and columns of frame data numbers of the mirror data 112. The frame data 114 are arranged in order of successive addresses of the micromirrors 40 of the DMDs 36. The generated frame data 114 are transmitted and stored in the buffer 94, depending on the position to which the DMDs 36 are moved in the scanning direction.

In the exposure recording apparatus 10, the exposure stage 18 is moved in a direction from the scanner 26 toward the CCD cameras 22a, 22b. In step S13, the DMD controller 42 supplies the frame data 114 stored in the buffer 94 to the DMDs 1 through 3, which record a desired image on the board F by way of exposure.

Referring back to FIGS. 2 and 3, the laser beam L emitted from the light source unit 28 is introduced, through the optical fiber 30, into the exposure heads 24a through 24j. The laser beam L travels through the rod lens 32, is reflected by the reflecting mirror 34, and is applied to the DMDs 36.

The DMD controller 42 reads the frame data 114 from the buffer 94, in the order of frame data numbers, and selectively turns on and off the micromirrors 40 of the DMDs 36 according to the “0”s and “1”s that make up the frame data 114. The laser beam L, which is selectively reflected by the micromirrors 40, is magnified by the first focusing optical lenses 44, 46, and then is adjusted to a desired beam spot diameter by the microaperture array 54, the microlens array 48, and the microaperture array 56. Thereafter, the laser beam L is adjusted to a predetermined magnification by the second focusing optical lenses 50, 52, and guided to the board F.

The exposure stage 18 moves along the bed 14. While the exposure stage 18 moves, a desired image is recorded on the board F by the DMDs 36, which have exposure heads 24a through 24j thereof arrayed in a direction perpendicular to the direction in which the exposure stage 18 is moved.

When recording of the image on the board F based on the frame data is finished in step S14, the board F with the recorded image thereon is discharged from the exposure recording apparatus 10, and then supplied to a subsequent image developing process.

In the present embodiment, image recording data are stored as compressed mirror data 108 in the memory 84, and sent to the exposure unit 72. Thereafter, the frame data generator 92 decompresses the compressed mirror data 108 into frame data 114, as shown in FIG. 13A, and supplies the frame data 114 to the DMD controller 42.

In the compressed mirror data 108 shown in FIG. 11, the compressed data supplied to the micromirrors 40 has a total number of “58” as shown in FIG. 12B. If the frame data 114 shown in FIG. 13A are compressed by run-length encoding, then the compressed data has a total number of “121” as shown in FIG. 13B, which is about twice the number of the compressed mirror data 108.

The reason enabling such data compression is that, since the compressed mirror data 108 are generated substantially along a direction of the lines of the raster image data 102, the data can be compressed efficiently, with the regularity of the raster image data 102 being retained depending on the desired image. Specifically, the data can be compressed at a high compression ratio by classifying and storing the image recording data for the respective micromirrors 40. On the other hand, the frame data 114 cannot be compressed at a high compression ratio, because such data are not arranged as image recording data along the image and the data are highly random, lacking continuity between adjacent image recording data.

According to the present embodiment, after the compressed mirror data generator 75 of the data processor 70 generates the compressed mirror data 108, the compressed mirror data generator 75 can transmit the compressed mirror data 108 at high speed to the exposure unit 72, while retaining a high compression ratio. The frame data generator 92 of the exposure unit 72 decompresses the compressed mirror data 108 into frame data 114, which are supplied to the DMD controller 42 for efficiently recording an image on the board F by way of exposure.

In the above embodiment, compressed raster image data are sent from the RIP server 8 to the data processor 70. However, after mirror data are generated from the raster image data by the data processor 70, the mirror data may be compressed into compressed mirror data 108.

In the above embodiment, the data processor 70 generates the compressed mirror data 108 and sends the compressed mirror data 108 to the exposure unit 72 in order to generate frame data. However, the data processor 70 and the exposure unit 72 may be integrally combined, such that the compressed mirror data 108 and the frame data can be generated by a single processing means.

The memory for storing the compressed mirror data 108 (or uncompressed mirror data) may have performance details thereof determined depending on performance and cost demands. Specifically, since the length (size) of the mirror data can be determined bit by bit, the bus size of the memory can be designed flexibly. Stated otherwise, leeway in designing the memory is high, because image recording data having a mirror data structure are employed.

The exposure recording apparatus 10 can be used to expose a dry film resist (DFR) in a process for manufacturing multilayer printed wiring boards (PWBs), to form a color filter in a process for manufacturing liquid crystal displays (LCD), to expose a DFR in a process for manufacturing thin film transistors (TFTs), or to expose a DFR in a process for manufacturing plasma display panels (PDPs). The principles of the present invention are not limited to a spatial light modulator comprising DMDs, but are also applicable to image recording units in the form of ink jet recording heads.

Although a certain preferred embodiment of the present invention has been described above, it should be understood that various changes and modifications may be made to the embodiment without departing from the scope of the invention as set forth in the appended claims.

1. An image recording apparatus for forming a two-dimensional image on an image recording surface by relatively moving an image recording dot forming unit, having a plurality of image recording components for forming a group of image recording dots on the image recording surface, in a predetermined scanning direction on the image recording surface, and successively supplying frame data, which are made up of a plurality of image recording data corresponding to the group of image recording dots, to said image recording dot forming unit, thereby forming the group of image recording dots chronologically on the image forming surface, comprising:
image recording component chronological data generating means for generating image recording component chronological data as said image recording data, which are supplied chronologically to said image recording components according to a layout of said image recording components with respect to said image recording surface;
image recording component chronological data holding means for holding said image recording component chronological data as compressed data; and
frame data generating means for acquiring compressed image recording component chronological data from said image recording component chronological data holding means, and decompressing the compressed image recording component chronological data into said frame data corresponding to the group of image recording dots.

2. An image recording apparatus according to claim 1, wherein said image recording components of said image recording dot forming unit are inclined at a predetermined angle with respect to said scanning direction, and said frame data comprise said image recording data arranged in a direction in which said image recording components are arranged.

3. An image recording apparatus according to claim 1, wherein said image recording dot forming unit comprises a spatial light modulator including said image recording components.

4. An image recording apparatus according to claim 3, wherein said spatial light modulator comprises a digital micromirror device comprising a two-dimensional array of micromirrors having reflecting surfaces for reflecting a light beam, said reflecting surfaces being angularly variable depending on said image recording data.

5. An image recording apparatus according to claim 1, wherein said image recording component chronological data generating means generates said compressed image recording component chronological data from compressed image recording data.

6. A method of recording a two-dimensional image on an image recording surface by relatively moving an image recording dot forming unit, having a plurality of image recording components for forming a group of image recording dots on the image recording surface, in a predetermined scanning direction on the image recording surface, and successively supplying frame data, which are made up of a plurality of image recording data corresponding to the group of image recording dots, to said image recording dot forming unit, thereby forming the group of image recording dots chronologically on the image forming surface, comprising the steps of:
generating image recording component chronological data as said image recording data, which are supplied chronologically to said image recording components according to a layout of said image recording components with respect to said image recording surface;
holding said image recording component chronological data as compressed data; and
acquiring compressed image recording component chronological data, decompressing the compressed image recording component chronological data into said frame data corresponding to the group of image recording dots, and supplying said frame data to said image recording dot forming unit.

7. A method according to claim 6, wherein said image recording components of said image recording dot forming unit are inclined at a predetermined angle with respect to said scanning direction, and said frame data comprise said image recording data arranged in a direction in which said image recording components are arranged.

8. A method according to claim 6, wherein said image recording dot forming unit comprises a spatial light modulator including said image recording components.

9. A method according to claim 8, wherein said spatial light modulator comprises a digital micromirror device comprising a two-dimensional array of micromirrors having reflecting surfaces for reflecting a light beam, said reflecting surfaces being angularly variable depending on said image recording data.

10. A method according to claim 6, wherein said compressed image recording component chronological data are generated from compressed image recording data.

11. A data structure defining a plurality of image recording data to be set in an image recording apparatus for forming a two-dimensional image on an image recording surface by relatively moving an image recording dot forming unit, having a plurality of image recording components for forming a group of image recording dots on the image recording surface, in a predetermined scanning direction on the image recording surface, and successively supplying frame data, which are made up of a plurality of image recording data corresponding to the group of image recording dots, to said image recording dot forming unit, thereby forming the group of image recording dots chronologically on the image forming surface,
wherein at least a portion of said image recording data comprises image recording component chronological data, which are arranged in an order in which the image recording component chronological data are successively supplied chronologically to said image recording components.

12. A data structure according to claim 11, wherein said image recording component chronological data comprise data compressed in a direction in which the data are arranged.

13. A recording medium storing said image recording component chronological data having the data structure according to claim 11.

14. A recording medium storing said image recording component chronological data having the data structure according to claim 12.

15. A data processing apparatus for dividing image recording component chronological data having the data structure according to claim 11 into a plurality of data groups, and processing said data groups in a parallel relationship so as to generate frame data corresponding to said group of image recording dots.

16. A data processing apparatus for dividing image recording component chronological data having the data structure according to claim 12 into a plurality of data groups, and processing said data groups in a parallel relationship so as to generate frame data corresponding to said group of image recording dots.

17. A data processing apparatus for dividing image recording component chronological data having the data structure according to claim 11 into a plurality of data groups, and transmitting said data groups in a parallel relationship.

18. A data processing apparatus for dividing image recording component chronological data having a data structure according to claim 12 into a plurality of data groups, and transmitting said data groups in a parallel relationship.

19. A method of processing data, comprising:
dividing image recording component chronological data having the data structure according to claim 11 into a plurality of data groups; and
processing said data groups in a parallel relationship so as to generate frame data corresponding to said group of image recording dots.

20. A method of processing data, comprising the steps of.
dividing image recording component chronological data having the data structure according to claim 12 into a plurality of data groups; and
processing said data groups in a parallel relationship so as to generate frame data corresponding to said group of image recording dots.

21. A method of processing data, comprising:
dividing image recording component chronological data having the data structure according to claim 11 into a plurality of data groups; and
transmitting said data groups in a parallel relationship.

22. A method of processing data, comprising:
dividing image recording component chronological data having the data structure according to claim 12 into a plurality of data groups; and
transmitting said data groups in a parallel relationship.

23. A method of handling a plurality of image recording data to be set in an image recording apparatus for forming a group of image recording dots on an image recording surface by relatively moving a plurality of image recording components on the image recording surface in a predetermined scanning direction, and successively supplying frame data including the plurality of image recording data to said plurality of image recording components, thereby forming the group of image recording dots chronologically on the image forming surface,
the method comprising arranging at least a portion of said plurality of image recording data in an order of being supplied to each of said image recording components.
